(19) United States
(12) Patent Application Publication
(10) Pub. No.: US 2007/0147614 A1
(43) Pub. Date: Jun. 28, 2007

(54) Method and system for rendering read-only storage medium virtually re-writable

(75) Inventors: Declan Patrick Kelly, Shanghai (CN); Bei Wang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/579,415

(22) PCT Filed: Nov. 15, 2004
(86) PCT No.: PCT/IB04/52421

§ 371 Date: May 15, 2006

(30) Foreign Application Priority Data
Nov. 18, 2003 (EP) 03104252.6

(51) Int. Cl. H04K 1/00

(52) U.S. Cl. 380/270; 709/215

(57) ABSTRACT

A method (1,2) of and system (3) for rendering a removable read-only storage medium (30) virtually re-writable by providing a unique medium identifier (43) for the read-only storage medium (30) and by providing a link to a networked storage area of a mass storage device, wherein access to said storage area is granted by said medium identifier. According to one embodiment access to said network storage area is limited to a restricted area, wherein the writable option only works within the restricted area. According to another embodiment, a Blu-Ray ROM disc is linked to user-specific contents on a network storage device. This allows the Blu-Ray ROM disc, being identified by a unique medium identifier, e.g. based on a barcode in the Burst Cutting Area (42) of the disc, to have an identical user defined behaviour on arbitrary players connected to the network.

This invention pertains in general to the field of storage media, and more particularly to read-only storage media, and even more particularly to rendering removable read-only storage media virtually re-writable.

Removable storage media offer more and more storage capacity. An example for this development is the evolution from CD to DVD and further to DVR, also called Blu-Ray disc. These disc-shaped digital storage media are generally provided in three versions, namely erasable re-writable (RW), write-once (R) and read-only (ROM). However, for many applications, the read-only version is preferred. This is caused by e.g. cheaper manufacturing of large volumes having stored identical content, commonly copyrighted or user-specific content. A further reason is that devices capable of both writing to, i.e. recording content, and reading from such storage media are more complicated and costly than devices for solely reading content from these storage media. However, for certain applications, it would be advantageous if user specific information could be stored even on a read-only storage medium.

A solution to this problem has been proposed in EP-A-0591636, wherein a removable magneto-optical disk medium is disclosed. This storage medium is physically sub-divided into a partial ROM and a partial RAM region. This solution provides a tailor-made storage medium and involves expensive manufacturing. Furthermore a special non-standard drives is needed for accessing both the ROM and RAM data of this storage medium.

Thus, the problem to be solved by the invention is to provide a removable storage medium being on the one hand physically read-only and on the other hand providing to a user of the storage medium the appearance of a writable storage medium, i.e. the user may for instance apparently access data, modify data or add data to and from the storage medium, although the storage medium in practice is read-only. Furthermore these modifications should be permanent from a user point of view, i.e. changes once performed should be remembered by the system, independently from the player on which the removable read-only storage medium is accessed.

The present invention overcomes the above-identified deficiencies in the art and solves at least the above identified problems by providing a method, a system and a computer-readable medium according to the appended patent claims.

The general solution according to the invention is to render a removable read-only storage medium virtually re-writable. A unique medium identifier is provided the removable read-only storage medium and a link to a networked storage area of a mass storage device is provided. Access to said storage area is granted by means of said medium identifier. Generally, the invention applies to all such media being read-only, either physically, i.e. the above-mentioned types (R) and ROM, or logically, where e.g. a flag on the media prevents writing to areas on the media having stored content.

More particularly, a pure ROM disc (Read Only Memory) is used as if it were a RW disc. According to the embodiment the RW part is indeed of unlimited capacity. Preferably this is established by a wireless access to the network.

According to aspects of the invention, a method, a system and a computer-readable medium for rendering a removable read-only storage medium virtually re-writable are disclosed.

Further objects, features and advantages of the invention will become apparent from the following description of embodiments of the present invention, reference being made to the accompanying drawings, in which

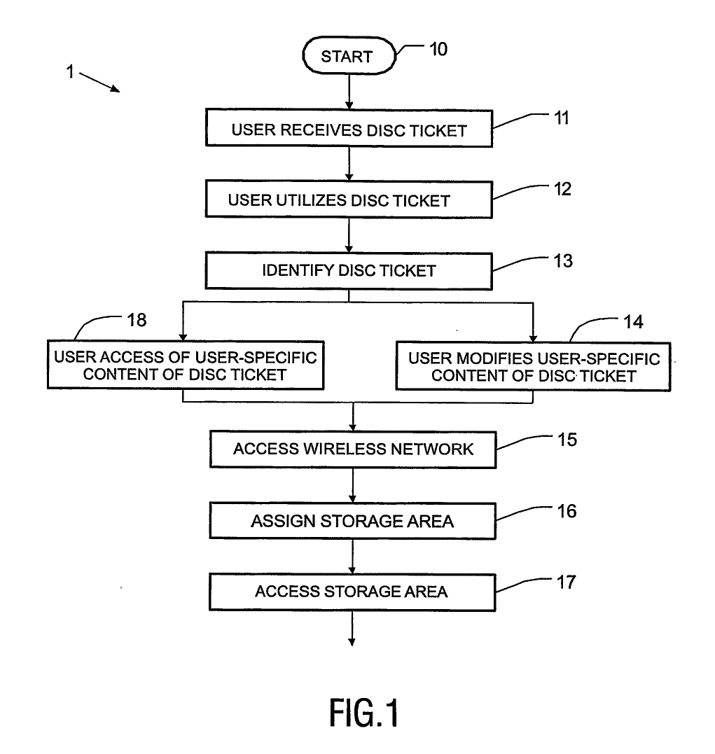

FIG. 1 is a schematic flowchart illustrating an embodiment of the invention;

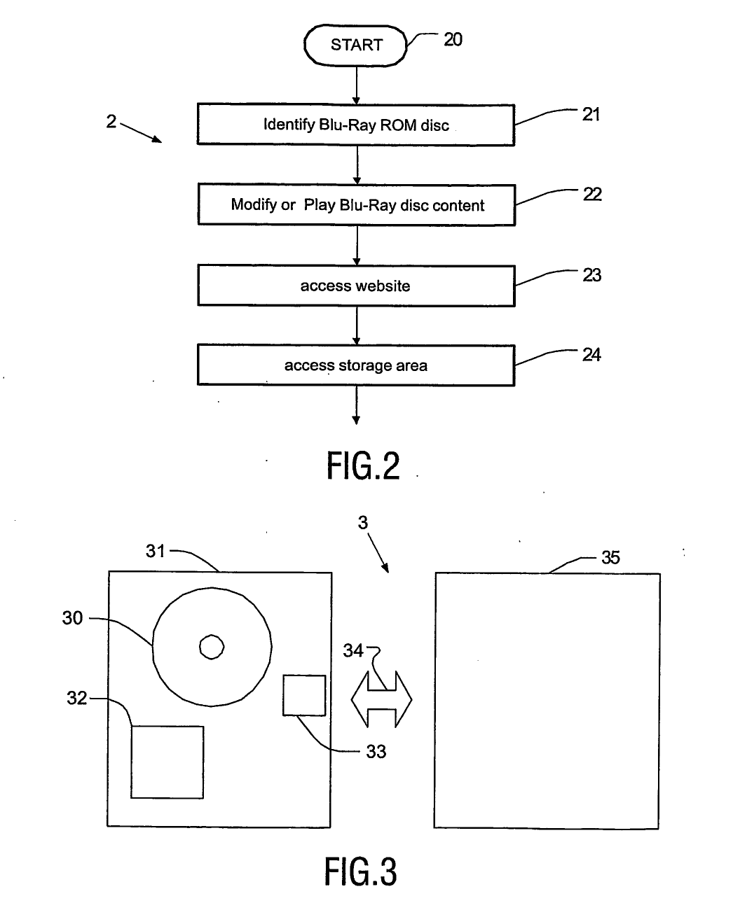

FIG. 2 is a schematic flowchart illustrating another embodiment of the invention;

FIG. 3 is a schematic diagram illustrating an exemplary system implementing an embodiment of the invention;

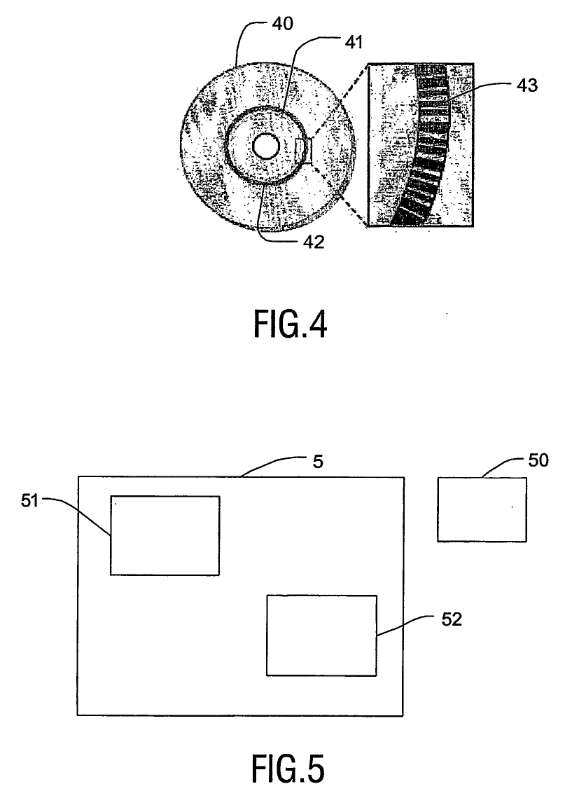

FIG. 4 is a schematic view illustrating a unique identifier of a removable read-only storage medium; and

FIG. 5 is a schematic diagram illustrating a computer-readable medium according to the invention.

Generally, an SFFO (Small Form Factor Optical) disc is characterized as a portable, high storage capacity and low cost format. The market studies and surveys on SFFO show universal interest among consumers for SFFO due to its advantages. Many potential applications around SFFO are envisioned.

One application is to use an SFFO ROM disc as a combined ticket/guidebook for e.g. a museum, theme park, or in general events having a controlled admission, usually associated with an admission fee, such as sports events. In particular SFFO may be used as a season ticket re-usable during different occasions, so the express intention that the user returns repeatedly is involved.

According to a first particular embodiment of the invention, such an SFFO ROM disc ticket is enhanced with user-specific information, virtually rendering the disc ticket re-writable MW). The embodiment aims to provide advanced features in such a situation that usually requires a hybrid ROM/RW disc, yet with only a pure ROM disc. This approach also provides a number of advantages for the operator of the particular attraction, as will be apparent from the description below.

Basically, the disc ticket is published on a pure ROM disc (Read Only Memory) but the user uses the disc as if it were a RW disc. According to the embodiment the RW part is indeed of unlimited capacity, which is a clear advantage over any removable storage medium, which will have a limited storage capacity in any case, no matter how high. This is implemented by storing all user information on a network. Storage capacity is easily adapted to the current needs of the user or application the user is running. This network is accessed when the user utilizes the disc ticket. Preferably this is established by a wireless access to the network.

In general the network is accessed via a connection offering a sufficiently high bandwidth in order to be not too slow. One possibility is to use a mobile network, e.g. a mobile phone network such as WCDMA or GSM. However, in specific cases mobile networks may be too expensive to use. Furthermore, it may not be desired that the additional user-specific information can be accessed from any location, as the e.g. the collection of additional user-specific information is restricted to the area, to which the ticket admits entrance. For instance, a museum disc ticket only allows collection of information within the premises of the muses, e.g. tracking which pieces of art the disc ticket user has been watching. In this case a less expensive alternative is that the system uses a local wireless network, such as a WiFi network (WiFi=Wireless Fidelity, the trade mark of the ISO 802.11b norm) provided by the access administrator offering the disc ticket at the site/premises to which the disc ticket gives admission to, e.g. a museum, theme park or football stadium. Thus, within this restricted area this high bandwidth WiFi network is provided without high cost for the user, as the user usually will pay for this feature e.g. as part of the ticket, and not the network usage. In this way, the user can easily add content to the disc, wherein the content is stored on the high bandwidth network within the restricted area for which the disc ticket is relevant. Access to the network is established by using a disc-ticket read-out device. This device may be a standard SFFO reader implemented in a network access device, such as a personal device handed out to the user at the entrance of the access site. A more detailed description of such devices is given below. In general, an SFFO disc as a portable, high capacity and low cost storage medium is well suitable for use in mobile hand-sets and other portable devices, such as PDAs or tablet-PCs.

This embodiment will now be further elucidated with reference to FIG. 1, wherein a method 1 for rendering an SFFO ROM disc ticket is from a user point of view made virtually re-writable. The method 1 comprises the following steps beginning with starting point 10. In step 10, a user receives a disc ticket, e.g. when entering for instance a theme park. The disc ticket is of the SFFO ROM type having stored thereon specific information concerning the theme park. Having entered the theme park, the user utilizes disc ticket in step 11, e.g. at different attractions of the theme park. When the user utilizes the disc ticket, the disc ticket is identified, e.g. by a user id entered by the user or by an identifier of the disc itself with a unique id. In step 14 the user modifies the content of the disc ticket, e.g. by adding content, such as images taken. The added user-specific content is in step 15 transmitted to and/or from e.g. a handheld device, the user utilizes the disc ticket with, via a network, preferably a wireless network such as the above-mentioned WiFi-type. At a location remote of said user and handheld device, a storage area is in step 16 assigned to said disc ticket on a networked read-writable mass-storage medium, e.g. on a remote central server being connected to the wireless network. The storage area for storing said user-defined content is accessed in step 17, together with link information that this content refers to the disc-ticket having the unique id, on a read-writable mass storage medium of a device connected to said network. Alternatively to modifying content (step 14), the user may accesses user-defined content of said uniquely identified disc ticket previously stored on the mass storage medium. In this case content is transmitted from the mass-storage medium to the handheld device of the user, and the user has the virtual impression of using a read-writable disc ticket as user-defined content is virtually accessible from it.

Visitors who have the disc ticket for e.g. a theme park or museum may already possess, or alternatively be provided, such an above-mentioned handheld device, to read the data on the disc ticket. At the same time, the device should allow the visitors to add more content to the disc, as mentioned above. Such content addition may comprise annotations the user makes for each exhibit within a museum and the photos they take in some interesting areas. The device can be either an SFFO dedicated device or combined with other portable devices, such as PDA, mobile phone, etc. These devices generally have the following features:
An SFFO disc drive for disc reading data from the disc, error detection and correction operations, etc.
An Internet connection wired or wireless and e.g. a web browser. In case the visitors accesses the park/museum website and downloads content from the web, the device provides web-connectivity either wired or wireless. A simple web browser is generally provided on the device in order to navigate web content.
A simple real time authoring tools for adding new content in order to allow the visitors to add their own content that is linked to appropriate content locations. The real-time authoring tool is provided on the device, and the tool has a user-friendly interface and is easy to operate.
SFFO disc player means for content navigation in order to browse the content on the disc either before during, or after the visit. The navigator usually supports menus, playlists, user interactions, etc.
A display screen or touch screen for menu operation and content navigation/display, which may be a touch screen, allows the user to type input. Otherwise the device may have other input means, such as a keyboard for typing.
Optionally video, audio recording and camera function are provided by the device.

At home the user may also access the user-specific network content through a standard Internet connection, preferably with a broadband connection, being sufficiently fast for the expected usage. The user may also cache the content on their PC. This offers the advantage for the operator of the access site, such as a tourist attraction, that the user's personal annotations/pictures etc. are stored on the operators system and so this naturally brings the user back to their web site. In this way a sticky user interaction is provided allowing e.g. new attractions to be promoted easily.

As well as storing the user's own information, this system may also be used to update parts of the ROM content on the disc ticket.

A few examples of what is possible with such a disc ticket are given hereinafter. The disc ticket may be an admission ticket for a theme park. At the theme park the user may add their own photos and link these photos to the location where they were taken or add their own comments/annotations.

Presenting a ROM disc as if it were a RW disc to the user by storing all the written parts on a network, allows the user to delete, annotate and add content to the disc. The presentation of the ROM and RW parts to the user is provided to be seamless, so the user does not perceive a difference to a RW disc. This feature is limited to a restricted area where the disc is relevant and within this limited area a high bandwidth wireless network, e.g. WiFi, is supplied to support this feature. The same network content may also be presented through the fixed Internet so users can see their personal additions at home.

While in the theme park the user needs a device that can read the disc ticket/guide and connect to the local WiFi network. When the user first enters the park, or least the coverage area of the WiFi network, the system identifies the user. This may for instance be implemented by a unique disc id, by the user's device identifying them, or by the user explicitly entering a username and password. Once the device has connected it starts displaying the content on the hybrid disc, i.e. the ROM part plus the changes stored on the network. Preferably, the system initially only transfers the changes to the start-up part of the disc, such as a contents or main page for a guide, such that not all the network updates are required and so start-up does not take too long time. When the user moves through the park and follows the guide on the disc, the system may transfer required updates to the disc content. In all cases this is done without user intervention.

To improve performance, the system may predict which parts the user will look at next and pre-cache them in the local device. This may be done, either by the device requesting them, and so could adapt to user's pattern of behaviour. Alternatively this may be performed based on a pattern of behaviour of a set of users. In the case of a guide to a museum/theme park, the users physical location gives an indication of which information he is likely to look at next so the device can pre-cache the network updates for all surrounding parts of the museum/theme park. In addition the system can take the user's logical location, i.e. the part of the museum/theme park that the user is currently viewing, and based on that information, cache the parts that are physical close to the current logical position. The network is dedicated to this application so neither the operator or the user is paying for individual transfers so in general the network utilises all available bandwidth to improve the user performance. If the network becomes overloaded the system may gracefully degrade.

Updating the information is generally only possible within the restricted area, e.g. the WiFi network covering the theme park/museum, but the user may also connect to a web site and again see his disc as re-writable.

In another embodiment of the invention, a DVD or a Blu-Ray ROM disc is provided having a unique identifier for every disc. This identifier is for instance based on the Burst Cutting Area (BCA) 41 of a DVD/Blu-Ray ROM disc 40, as illustrated in FIG. 4. The BCA is an annular area 42 within the disc hub where a bar code 43 is written for additional information, such as serial numbers of the discs. The BCA may be written during mastering and will be common for all discs from that master or, more usually, will be written using a YAG laser to ‘cut’ the barcode into the reflective layer of the finished disc. A non-limiting example for the data stored in the BCA is e.g. in the range from 12 bytes to 188 bytes in steps of 16 bytes. The BCA, providing such a unique media ID, is usually used for copy prevention systems. However, according to the present embodiment of the invention, the identifier supplied by the Burst Cutting Area is used to identify the read-only disc and to associate network-stored information with unique discs.

As well as including BCA, a Blu-ray ROM application includes Internet Connectivity. Using the BCA and the Internet link allows a disc author to make the ROM disc re-writable by storing the modifications on the Internet using the BCA to identify the particular disc of a title. This means the user can modify the disc on one player and the modifications will be seen on any other networked player, so the disc seems re-writable to the user. This is controlled by an application on disc. For example, the disc could include a Java Application that allows the user to edit the content i.e. define new PlayLists. These PlayLists will then appear in the menu system like authored PlayLists. Similarly, the user may configure the appearance of the menus. For example, the user chooses a favourite character and that character helps the user to navigate through menus. Another case where the invention applies is where users annotate ROM discs, e.g. at home for e.g. cook book, and the annotations are stored on a network device, in this case the annotations may be shared, e.g. with friends/family through e.g. the Internet.

The implementation is as follows. The disc and the applications on them links to a designated web site, which is determined by the content author. This web site stores the modifications according to disc title indexed by BCA. Known techniques such as hash tables may be used to optimise searching.

The above-mentioned embodiment is now further explained by reference to FIG. 2. The method 2 starts at starting point 20, at which a Blu-Ray ROM disc is used in e.g. a Blu-Ray player, in order to access content stored on the disc. The content is for instance a movie having a sequence of scenes. In step 21 the Blu-Ray ROM disc is identified, e.g. by means of the above-mentioned code stored in the BCA. In step 22, the content of the Blu-Ray ROM disc is in step 23 either modified with user-specific information, e.g. the PlayList is redefined, or the disc is played with consideration of previously user-defined content. In both cases, a designated Internet web-site is accessed by said player via an Internet network connection accessible by said player. At the website, a read-writable storage area is in step 24 accessed by means of said identity information of the disc. This storage area does either store new or amended user-specific information related to the specific disc, or previously stored user-specific information is retrieved from this storage area.

In the case that the medium identifier is a user id, as mentioned above, a group of users who share the same network storage space may be defined. This allows the users to share the same changes. More specifically, a group of users having different individual user ids may share the same network storage area, such that when one user of the group of users modifies the content in said network storage area, all remaining users will experience the same changes when using identical copies of said read-only storage medium.

According to an embodiment of another aspect of the invention, FIG. 3 illustrates a system 3 for rendering a removable read-only storage medium 30 virtually re-writable. The system comprises a handheld device 31 having means 32 for providing a unique medium identifier for said removable read-only storage medium 30, for instance an input means, such as a touch-screen or a keyboard, for entering a user id, or a reader for a BCA-code. Furthermore, the handheld device 31 has means 33 for providing a link to a networked storage area of a mass storage device 35, namely a network card allowing access to the networked storage area via a network connection 34. Access to said storage area is granted by means of said medium identifier.

A computer-readable medium according to an embodiment of a further aspect of the invention is shown in FIG. 5. The computer-readable medium 5 has embodied thereon a computer program for processing by a computer 50. The computer program comprising code segments for rendering a removable read-only storage medium virtually re-writable. A first code segment 51 provides a unique medium identifier for said removable read-only storage medium, and a second code segment 52 provides a link to a networked storage area of a mass storage device, wherein access to said storage area is granted by means of said medium identifier.

Applications and use of the above described method, system and computer-readable medium concerning virtually re-writable removable read-only storage media according to the invention are various and include exemplary fields such as the above-mentioned disc tickets for theme parks, events etc., personalized storage media that are only readable but still have user-specific information, such as DVD players, software distributed on read-only media, still being up-to-date, etc. Moreover, the invention also applies to write-once discs (R), or also to storage media that have content, which is logically ROM so there is a flag on the disc to indicate that it should not be changed even though the disc is RW.

The present invention has been described above with reference to specific embodiments. However, other embodiments than the preferred above are equally possible within the scope of the appended claims, e.g. different wireless networks or disc reading devices than those described above, performing the above method by hardware or software, etc.

Furthermore, the term “comprises/comprising” when used in this specification does not exclude other elements or steps, the terms “a” and “an” do not exclude a plurality and a single processor or other units may fulfil the functions of several of the units or circuits recited in the claims.

The invention can be summarized as follows:

A method of and system for rendering a removable read-only storage medium (30) virtually re-writable by providing a unique medium identifier for the read-only storage medium and by providing a link to a networked storage area of a mass storage device, wherein access to said storage area is granted by said medium identifier. According to one embodiment access to said network storage area is limited to a restricted area, wherein the writable option only works within the restricted area. The restricted area is in this case, for example, a museum or a theme park and the storage medium for example an SFFO disc ticket. According to another embodiment, a Blu-Ray ROM disc is linked to user-specific contents on a network storage device. This allows the Blu-Ray ROM disc, being identified by a unique medium identifier, e.g. based on a barcode in the Burst Cutting Area (42) of the disc, to have an identical user-defined behaviour on arbitrary players connected to the network.

1. A method of rendering a removable storage medium virtually re-writable, on which storage medium information is stored read-only, said method comprising the steps of
providing a unique medium identifier for said removable read-only storage medium,
providing a link to a networked storage area of a mass storage device, wherein access to said storage area is granted by means of said medium identifier.

2. The method according to claim 1, wherein said storage medium is an optical disc.

3. The method according to claim 2, wherein said optical disc is chosen from a CD, DVD, SFFO disc, Blu-Ray disc.

4. The method according to claim 1, wherein said link is a wireless access link to a network.

5. The method according to claim 4, wherein said wireless access link only is operative within a restricted area.

6. The method according to claim 1, wherein said storage medium is a ticket having stored thereon information concerning a physical site said ticket providing access to.

7. The method according to claim 6, wherein said physical site is a theme park, museum or event location.

8. The method according to claim 1, said method comprising modifying the content in said storage area when using said storage medium, said modifying step comprising virtually changing, adding or deleting content to content stored on said removable storage medium.

9. The method according to claim 1, wherein said medium identifier is a user id provided by a user when accessing said storage medium.

10. The method according to claim 9, wherein a group of users having different individual user ids share the same network storage area, such that when one user of the group of users modifies the content in said network storage area, all remaining users will experience the same changes when using identical copies of said read-only storage medium.

11. The method according to claim 2, wherein said medium identifier is a unique identification code in the Burst Cutting Area (BCA) of the optical disc.

12. A system (3) for rendering a removable read-only storage medium (30) virtually re-writable, said system (3) comprising
means (32) for providing a unique medium identifier for said removable read-only storage medium (30),
means (33) for providing a link to a networked storage area of a mass storage device (35), wherein access to said storage area is granted by means of said medium identifier.

13. The system (3) according to claim 12, wherein a portable disk-based information device (31) comprises a reader for said read-only storage-medium (30), said portable device (31) being operably connected to said mass storage device (35) via a network (34).

14. The system (3) according to claim 13, wherein said network (34) is a wireless communication network.

15. The system (3) according to claim 14, wherein said wireless communication network is a local network having a range limited to a site.

16. A computer-readable medium (5) having embodied thereon a computer program for processing by a computer (50), the computer program comprising code segments for rendering a removable read-only storage medium virtually re-writable, comprising
a first code segment (51) for providing a unique medium identifier for said removable read-only storage medium, and
a second code segment (52) for providing a link to a networked storage area of a mass storage device, wherein access to said storage area is granted by means of said medium identifier.
